(19) United States
(12) Patent Application Publication
(10) Pub. No.: US 2007/0169203 A1
(43) Pub. Date: Jul. 19, 2007

(54) Method and apparatus for transmitting content to device which does not join domain

(75) Inventors: Bong-seon Kim, Seongnam-si (KR); Young-sun Yoon, Suwon-si (KR); Su-hyun Nam, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/592,265

(22) Filed: Nov. 3, 2006

Related U.S. Application Data
(60) Provisional application No. 60/759,965, filed on Jan. 19, 2006.

(30) Foreign Application Priority Data
Apr. 24, 2006 (KR) 10-2006-0036821

(51) Int. Cl. H04N 7/16

(52) U.S. Cl. 726/26

(57) ABSTRACT

A method and an apparatus for transmitting content from a first device that joins a domain to a second device that does not join the domain are provided. If the second device which does not join the domain is adjacent to the first device which joins the domain, by encrypting a content key corresponding to the content to be transmitted to the second device which does not join the domain using a key of the second device which does not join the domain, and then transmitting the content and the encrypted content key to the second device which does not join the domain, the second device which does not join the domain can use the content having an access authority limitation, which can be used by only devices which join the domain.

### CROSS-REFERENCE TO RELATED PATENT APPLICATION

This application claims priority from U.S. Provisional Patent Application No. 60/759,965, filed on Jan. 19, 2006, in the United States Patents and Trademarks Office and Korean Patent Application No. 10-2006-0036821, filed on Apr. 24, 2006, in the Korean Intellectual Property Office, the disclosures of which are incorporated herein in their entirety by reference.

### BACKGROUND OF THE INVENTION

1. Field of the Invention

Methods and apparatuses consistent with the present invention relate to transmitting contents to a device which does not join a home domain, and more particularly, to a method and an apparatus for transmitting a content, which allow a device which does not join a specific domain to use a content having an access authority limitation for content protection so that only devices which join the specific domain can use the content, although the content itself is allowed to be randomly used by arbitrary devices.

2. Description of the Related Art

As devices allowing users to enjoy broadcasting, music, games, etc. in the home become various, a content that can be used in such devices also becomes various. Accordingly, consumers want to conveniently share a content among their own devices. In order to meet consumer demand, research into a home network domain that allows sharing of a content by connecting devices based on consumers is actively being conducted. Further, if devices which do not join a home network domain can use the content having an access authority limitation for allowing only devices which join the home network domain to use the content, consumers want to widen a shared range of the content so that they can use the content through external devices which do not join the home network domain.

### SUMMARY OF THE INVENTION

The present invention provides a method and an apparatus for allowing a user to use a desired content as necessary, by providing a content access authority to a device which does not join a specific domain, when the device which does not join the specific domain tries to use the content encrypted using a domain key for allowing use of the content to only devices which join the specific domain.

The present invention also provides a computer-readable recording medium storing a computer program for executing the method.

According to an aspect of the present invention, there is provided a method of transmitting a content from a first device which joins a domain to a second device which does not join the domain, including: checking adjacency between the first device and the second device; encrypting a content key corresponding to the content to be transmitted to the second device using a key of the second device, according to the adjacency check result; and transmitting the encrypted content key and the content to the second device.

According to another aspect of the present invention, there is provided a computer-readable recording medium storing a computer program for executing the method for transmitting the content from the first device which joins the domain to the second device which does not join the domain.

According to another aspect of the present invention, there is provided a method of allowing a second device which does not join a domain to receive a content from a first device which joins the domain, including: checking adjacency between the first device and the second device; and receiving the content and a content key corresponding to the content encrypted using a key of the second device, from the first device, according to the adjacency check result.

According to another aspect of the present invention, there is provided a computer-readable recording medium storing a computer program for executing the method for allowing the second device which does not join the domain to receive the content from the first device which joins the domain.

According to another aspect of the present invention, there is provided an apparatus for transmitting content to a device which does not join a domain, including: an adjacency checking unit which checks adjacency to the device; an encryption unit which encrypts a content key corresponding to the content to be transmitted to the device, with a key of the device, according to the adjacent check result of the adjacent checking unit; and a transmitting unit which transmits the content key encrypted by the encryption unit and the content corresponding to the content key to the device.

According to another aspect of the present invention, there is provided an apparatus for receiving content from a device which joins a domain, including: an adjacency checking unit which checks adjacency to the device; and a receiver which receives a content key encrypted using a key of the apparatus and the content corresponding to the content key, according to the adjacency check result of the adjacency checking unit.

### BRIEF DESCRIPTION OF THE DRAWINGS

The above and other features and advantages of the present invention will become more apparent by describing in detail exemplary embodiments thereof with reference to the attached drawings, in which:

FIG. 1 is a view for explaining a situation when content transmission is performed, according to an exemplary embodiment of the present invention;

FIG. 2 is a view for explaining an operation of transmitting content from a first device which joins a home domain to a second device which does not join the home domain, and an operation in which the second device receiving the content processes the received content, according to an exemplary embodiment of the present invention;

FIG. 3 is a flowchart illustrating a method performed by the first device, when content is transmitted from the first device which joins a home domain to the second device which does not join the home domain, according to an exemplary embodiment of the present invention;

FIG. 4 is a flowchart illustrating a method in which the first device which joins the home domain encrypts a content key corresponding to the content to be transmitted to the second device which does not join the home domain, according to an exemplary embodiment of the present invention;

FIG. 5 is a flowchart illustrating a method in which the second device which does not join the home domain receives the content from the first device which joins the home domain, according to an exemplary embodiment of the present invention; and

FIG. 6 is a block diagram showing a content transmitting apparatus which joins a home domain and a content receiving apparatus which does not join the home domain, according to an exemplary embodiment of the present invention.

### DETAILED DESCRIPTION OF THE INVENTION

Hereinafter, a method and apparatus for transmitting content to a device which does not join a predetermined domain, according to exemplary embodiments of the present invention, will be described in detail with reference to the appended drawings.

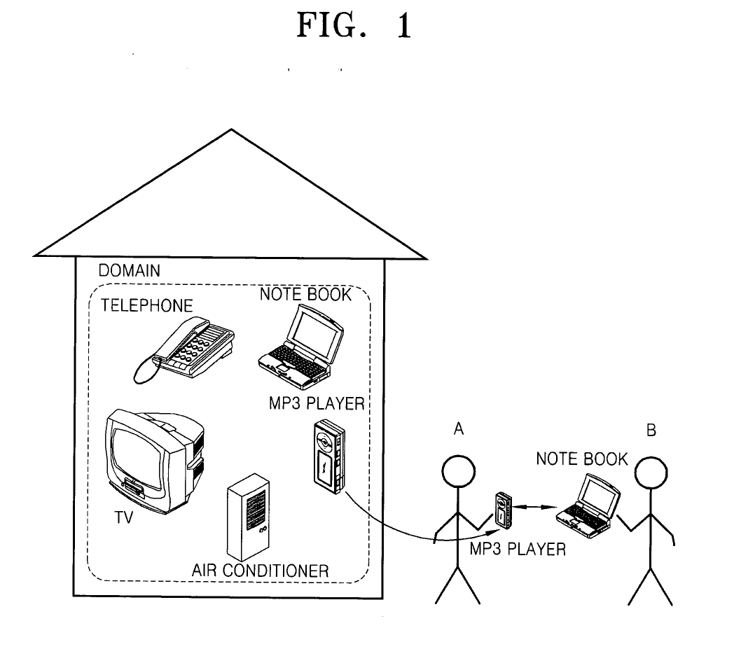

FIG. 1 is a view for explaining a situation when content transmission is performed, according to an exemplary embodiment of the present invention.

Referring to FIG. 1, in a home domain as illustrated in FIG. 1, a user using devices in the home domain can use a portable device such as an MP3 player, among the devices in the home domain, outside the home domain.

As such, when a user using devices in the home domain uses a portable device, such as an MP3 player, in the home domain, outside the home domain, if a content stored in the portable device in the home domain is allowed to be randomly used by arbitrary devices, a third party except for the user using the devices in the home domain can request use of the content stored in the portable device in the home domain, through a different device which does not join the home domain. However, the content stored in the devices in the home domain has an access authority limitation for allowing only the devices that join the home domain to use the content in order to protect the content. Accordingly, in order to allow a device that does not join the home domain to use a content stored in a device that joins the home domain, a method of providing a content access authority to a device that does not join the home domain is needed.

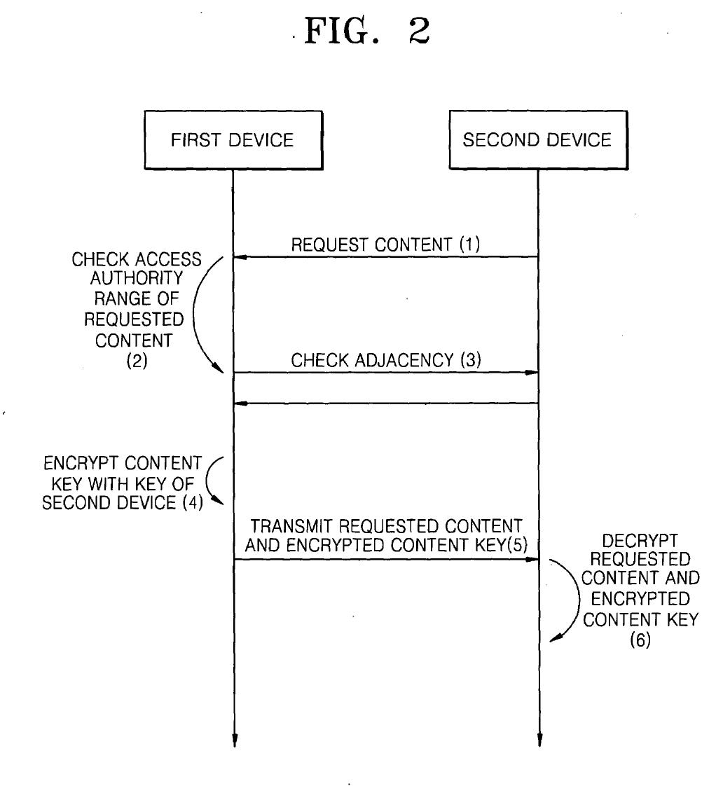

FIG. 2 is a view for explaining an operation of transmitting a content from a first device which joins a home domain to a second device which does not join the home domain, and an operation in which the second device receiving the content processes the received content, according to an exemplary embodiment of the present invention.

Referring to FIG. 2, the operation of transmitting a content from the first device to the second device and the operation in which the second device receiving the content processes the content are sequentially performed as follows.

In operation 1, the second device which does not join a home domain transmits a message requesting a content that the second device wants to use, to the first device which joins the home domain. At this time, the second device can transmit a secret key of the second device, together with the message requesting the content. Here, since the secret key of the second device means a key used by only the second device, the secret key of the second device must be transmitted to the first device through a safe path so that the secret key is not exposed to the outside.

In operation 2, the first device receiving the message requesting the content determines whether the content requested by the second device is allowed to be randomly used by arbitrary devices. The determination on whether the content is allowed to be randomly used by arbitrary devices can be performed by checking a license defining an access authority range of the content.

In operation 3, if the first device determines that the requested content can be used by devices which do not join the home domain as the access authority range of the content is not limited, the first device checks adjacency between the first device and the second device. The adjacency checking is criteria for determining whether the requested content can be used in the second device. The adjacency checking is performed to prevent content requested by the second device from being distributed without any restriction.

In operation 4, the first device encrypts a content key corresponding to the content to be transmitted to the second device, using a key of the second device, so that the content to be transmitted to the second device can be used by the second device. At this time, generally, the content key is encrypted using a public key according to a public key infrastructure. However, if a secret key of the second device is received, the content key can be encrypted using the secret key of the second device.

In operation 5, the first device transmits the content requested in operation 1 and the content key encrypted in operation 4 to the second device. Here, the content key encrypted in operation 4 is a content key corresponding to the content requested in operation 1.

In operation 6, the second device decrypts the encrypted content key using the key of the second device, and decrypts the encrypted content using the decrypted content key.

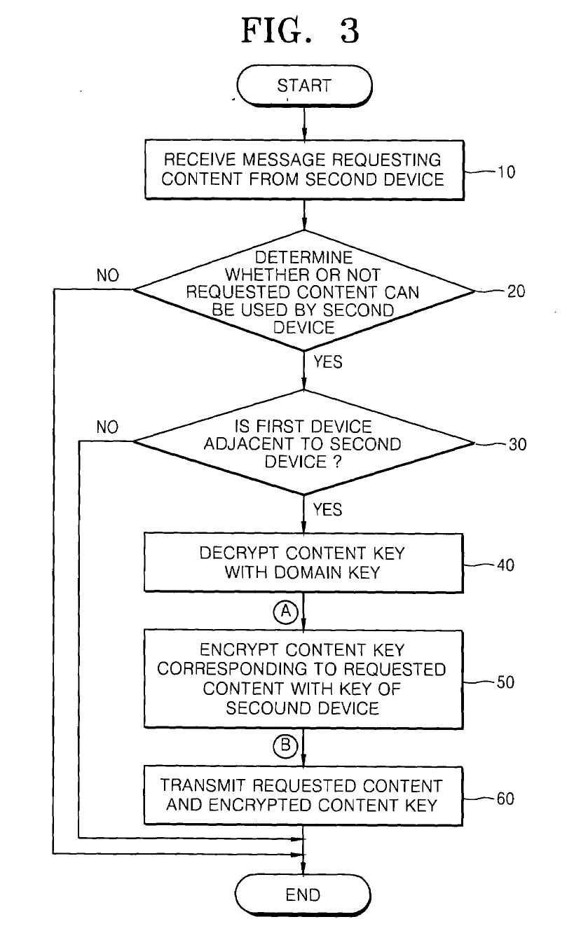

FIG. 3 is a flowchart illustrating a method performed by the first device, when a content is transmitted from the first device which joins a home domain to a second device which does not join the home domain, according to an exemplary embodiment of the present invention.

Referring to FIG. 3, an operation of transmitting a content from the first device to the second device is sequentially performed as follows.

In operation 10, the first device receives a message requesting a content which the second device wants to use, from the second device. By the message received from the second device, the content required by the second device can be determined. At this time, the first device can receive a secret key of the second device together with the content request message, from the second device. Here, since the secret key of the second device is a key used by only the second device, the secret key of the second device must be transmitted to the first device through a safe path so that the secret key is not exposed to the outside. The secret key of the second device received from the second device is used to encrypt a content key of the content requested by the second device.

In operation 20, the first device determines whether the content requested by the second device is allowed to be randomly used by arbitrary devices. The determination on whether the content has the access authority limitation is performed by checking a license defining an access authority range of the content. If it is determined through the license that the content is allowed to be used by the second device, the process proceeds to operation 30. Otherwise, the process is terminated.

Then, in operation 30, the first device checks adjacency to the second device and thus determines whether adjacency exists between the first device and the second device. The adjacency checking is performed to prevent the content requested by the second device from being distributed without any restriction. The adjacency checking is performed as follows.

The first device transmits a message for adjacency checking to the second device and receives a response message for adjacency checking from the second device. A Round Trip Time (RTT) value is obtained using a measured message transmission time and a measured response message receiving time. The first device compares the RTT value with an adjacency threshold value. If the RTT value is smaller than the adjacency threshold value, the first device determines that the first device is adjacent to the second device. If the first device determines that the first device is adjacent to the second device, the process proceeds to process 40. Otherwise, the process is terminated. In this exemplary embodiment, an RTT value is used for the adjacency checking, however, the present invention is not limited thereto.

In operation 40, since a content key of the content to be transmitted to the second device is encrypted with a domain key, the first device decrypts the content key using the domain key. That is, since the content to be transmitted to the second device is encrypted with a domain key, access authority to the content is limited so that only devices which join the corresponding domain can use the content. Accordingly, in order to allow the second device to use the content to be transmitted to the second device, an operation of decrypting the content key encrypted with the domain key is first needed.

Then, in operation 50, the first device encrypts a content key corresponding to the content to be transmitted to the second device by a request of the second device.

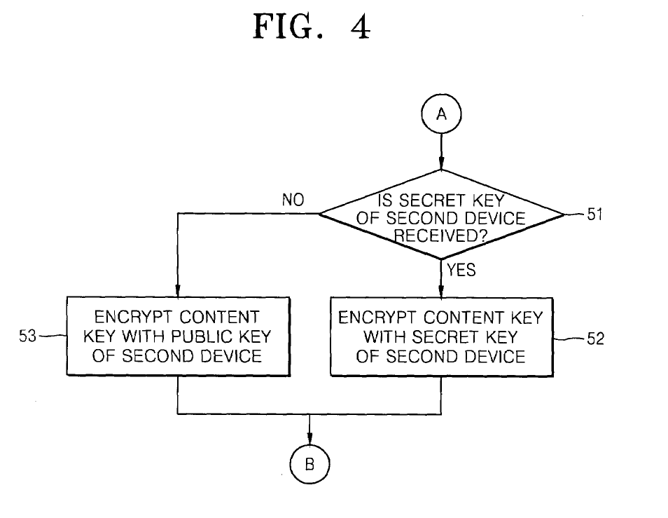

FIG. 4 is a flowchart illustrating a method in which the first device which joins the home domain encrypts the content key corresponding to the content to be transmitted to the second device which does not join the home domain, according to an exemplary embodiment of the present invention.

Referring to FIG. 4, in operation 51, the first device determines whether a secret key of the second device is received together with the message requesting transmission of the content from the second device (in operation 10 of FIG. 3). Generally, a secret key of each device is inherent to the device. However, when a content is exchanged between two devices and the exchanged content is used by a different device, there may be a case when a secret key is transmitted in need of encryption or decryption of the content. For this reason, the determination on whether a secret key of the second device is received is needed. As the determination result, if the first device receives the secret key of the second device, the process proceeds to operation 52. If the first device does not receive the secret key of the second device, the process proceeds to operation 53.

In operation 52, the first device encrypts the content key corresponding to the content to be transmitted to the second device, using the secret key of the second device, and then proceeds to operation 60. In the present exemplary embodiment, the first device receives the secret key of the second device when receiving the content request message from the second device (in operation 10 of FIG. 3), however, the present invention is not limited to this. The first device can receive the secret key of the second device from the second device as necessary and then encrypt the content key with the received secret key of the second device.

In operation 53, the first device encrypts the content key corresponding to the content to be transmitted to the second device, using a public key according to a public key infrastructure, and then proceeds to operation 60. Since the public key is a key open to the public and the first device also has the public key, the content key can be encrypted using the public key.

Returning to FIG. 3, in operation 60, the first device transmits the content key encrypted in operation 52 or 53 of FIG. 4 and the content requested in operation 10 to the second device.

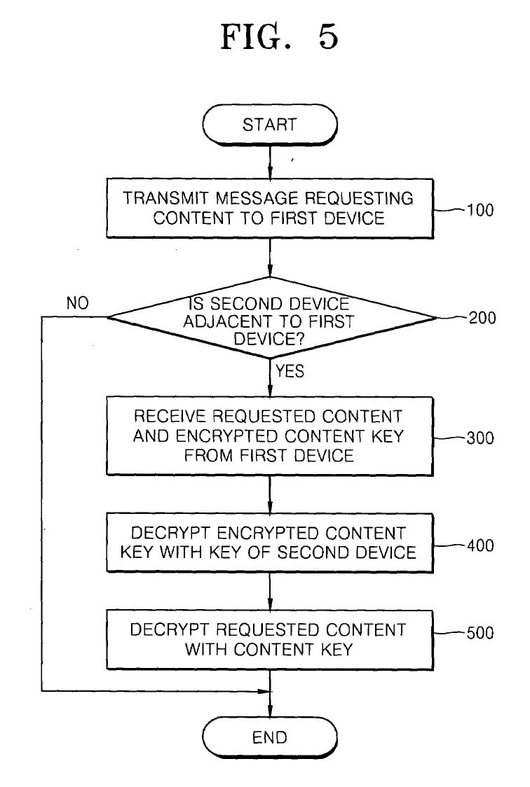

FIG. 5 is a flowchart illustrating a method in which the second device which does not join the home domain receives the content from the first device which joins the home domain, according to an exemplary embodiment of the present invention.

Referring to FIG. 5, the method in which the second device receives the content from the first device is sequentially performed as follows.

In operation 100, the second device transmits a message requesting the content which the second device wants to use, to the first device. At this time, the second device can transmit a secret key of the second device to the first device together with the content request message. Here, since the secret key of the second device is a key used by only the second device, the secret key of the second device must be transmitted to the first device through a safe path so that the secret key is not exposed to the outside.

In operation 200, the second device checks adjacency to the first device and thus determines whether adjacency exists between the second device and the first device. The adjacency checking is performed to prevent content requested by the second device from being distributed without any restriction. The adjacency checking is performed as follows.

The second device receives a message for adjacency checking from the first device and transmits a response message for adjacency checking to the first device. The first device obtains an RTT value using a message transmitting time and a response message receiving time measured when the message is transmitted and received. The first device compares the RTT value with an adjacency threshold value. If the RTT value is smaller than the adjacency threshold value, it is determined that the second device is adjacent to the first device. If it is determined through the adjacency checking that the second device is adjacent to the first device, the process proceeds to operation 300. Otherwise, the process is terminated. In this exemplary embodiment, a RTT value is used for the adjacency checking, however, the present invention is not limited to this.

In operation 300, the second device receives a content key encrypted by a key of the second device and the content corresponding to the request in operation 100, from the first device.

In operation 400, the second device decrypts the content key received in operation 300, using the key of the second device. Since the content key is encrypted with a public key or a secret key of the second device by the first device, the content key can be decrypted using a different method according to whether the content key is encrypted with the public key or the secret key of the second device. If the content key is encrypted with the public key, the content key is decrypted with a private key of the second device. If the content key is encrypted with the secret key of the second device, the content key is decrypted with the secret key of the second device. However, the present invention is not limited thereto, and the content key can be decrypted using various methods. After the content key is decrypted, operation 500 is performed.

In operation 500, the second device decrypts the encrypted content using the decrypted content key. The content is encrypted with the content key in order to protect its information. Since the content key is decrypted using the key of the second device in operation 400, the second device can use the decrypted content key without any restriction.

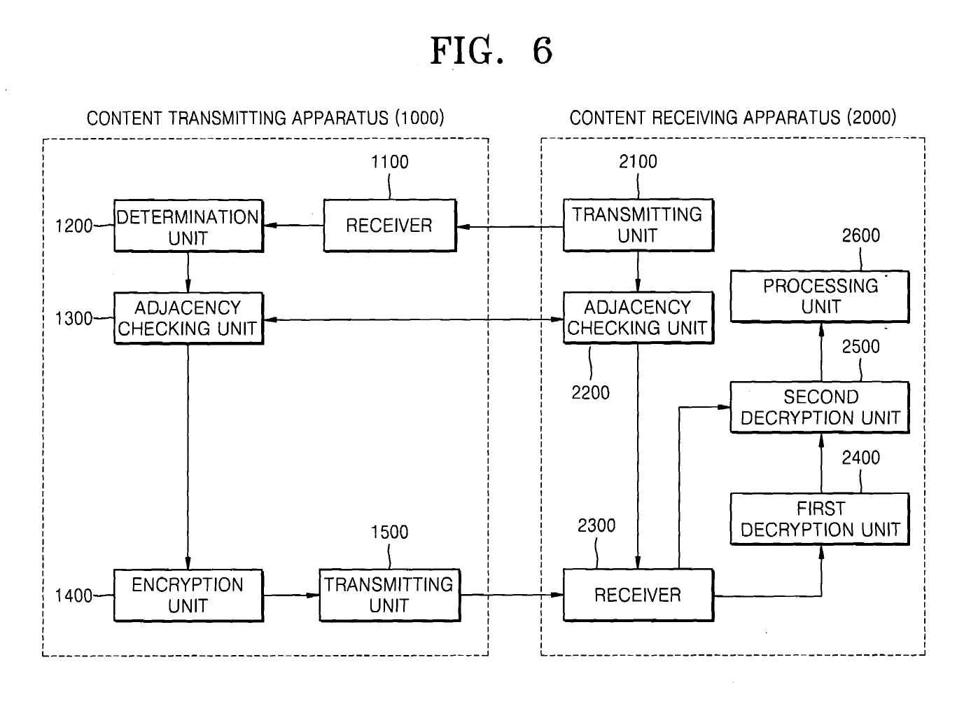

FIG. 6 is a block diagram showing a content transmitting apparatus 1000 which joins a home domain and a content receiving apparatus 2000 which does not join the home domain, according to an exemplary embodiment of the present invention.

The content transmitting apparatus 1000 includes a receiver 1100, a determination unit 1200, an adjacency checking unit 1300, an encryption unit 1400, and a transmitting unit 1500.

The receiver 1100 receives a message requesting content that the content receiving apparatus 2000 wants to use, from the content receiving apparatus 2000.

The determination unit 1200 determines whether the content requested by the content receiving apparatus 2000 is allowed to be randomly used by arbitrary devices which do not join the corresponding domain. Here, the determination on whether the content is allowed to be randomly used by arbitrary devices can be performed by checking a license defining an access authority range of the content.

If it is determined by the determination unit 1200 that the content requested by the content receiving apparatus 2000 is allowed to be randomly used by arbitrary devices (such as the content receiving apparatus 2000) which do not join the home domain, the adjacency checking unit 1300 checks adjacency to the content receiving apparatus 2000 and thus determines whether adjacency exists between the content transmitting apparatus 1000 and the content receiving apparatus 2000. The adjacency checking is performed to prevent content requested by the content receiving apparatus 2000 from being distributed without any restriction. The adjacency checking is performed as follows.

The adjacency checking unit 1300 transmits a message for adjacency checking to an adjacency checking unit 2200 of the content receiving apparatus 2000, and receives a response message for adjacency checking from the adjacency checking unit 2200 of the content receiving apparatus 2000. At this time, an RTT value is obtained using a measured message transmitting time and a measured response message receiving time. The adjacency checking unit 1300 of the content transmitting apparatus 1000 compares the RTT value with an adjacency threshold value. If the RTT value is smaller than the adjacency threshold value, it is determined that the content transmitting apparatus 1000 is adjacent to the content receiving apparatus 2000. In this exemplary embodiment, an RTT value is used for the adjacency checking, however, the present invention is not limited thereto.

The encryption unit 1400 encrypts a content key corresponding to the content requested by the receiver 1100, using a key of the content receiving apparatus 2000. The encryption unit 1400 transfers the encrypted content key to the transmitting unit 1500. At this time, the key of the content receiving apparatus 2000 used to encrypt the content key is a public key or a secret key, etc. of the content receiving apparatus 2000.

The transmitting unit 1500 transmits the encrypted content key transferred from the encryption unit 1400 and the content requested from the content receiving apparatus 2000 by the receiver 1100, to the content receiving apparatus 2000.

The content receiving apparatus 2000 includes a transmitting unit 2100, the adjacency checking unit 2200, a receiver 2300, a first decryption unit 2400, a second decryption unit 2500, and a processing unit 2600.

The transmitting unit 2100 transmits a message requesting a content which the content receiving apparatus 2000 wants to use, to the content transmitting apparatus 1000.

The adjacency checking unit 2200 receives a message for adjacency checking from the adjacency checking unit 1300 of the content transmitting apparatus 1000, and transmits a response message for adjacency checking to the adjacency checking unit 1300 of the content transmitting apparatus 1000. Then, it is determined whether adjacency exists between the content transmitting apparatus 1000 and the content receiving apparatus 2000, using an RTT value measured by the adjacency checking unit 1300 of the content transmitting apparatus 1000. In this exemplary embodiment, the RTT value is used for the adjacent checking, however, the present invention is not limited thereto.

The receiver 2300 receives the encrypted content key from the content transmitting apparatus 1000 and the content requested by the transmitting unit 2100, from the content transmitting apparatus 1000. The receiver 2300 transfers the received content to the second decryption unit 2500, and transfers the encrypted content key to the first decryption unit 2400.

The first decryption unit 2400 decrypts the encrypted content key received from the receiver 2300, using a key of the content receiving apparatus 2000. The key of the content receiving apparatus 2000 used for decrypting the encrypted content key is a private key or a secret key, etc. of the content receiving apparatus 2000. That is, if the content key is encrypted with a public key, the content key is decrypted with the private key of the content receiving apparatus 2000 according to the public key infrastructure. Also, if the content key is encrypted with a secret key, the content key is decrypted with the secret key of the content receiving apparatus 2000. The first decryption unit 2400 transfers the decrypted content key to the second decryption unit 2500.

The second decryption unit 2500 receives the content from the receiver 2300 and receives the decrypted content key from the first decryption unit 2400. The second decryption unit 2500 decrypts the content received from the receiver 2300 using the content key received from the first decryption unit 2400. The content decrypted using the content key is transferred to the processing unit 2600. Since the content is encrypted with the content key in order to protect its information, the content must be decrypted using the content key in order to use information stored in the content.

The processing unit 2600 receives the decrypted content from the second decryption unit 2500 and converts the decrypted content into a format suitable to the use of the content receiving apparatus 2000.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to the exemplary embodiments of the present invention, when a user using devices which join a home domain uses a portable device of the home domain outside the home domain, a third party except for the user using the devices in the home domain can request the use of content stored in the devices which join the home domain, through a different device which does not join the home domain. As such, according to the exemplary embodiments of the present invention, a method of providing content access authority to a device which does not join a home domain thus allowing the device to share content of the home domain is provided, when the device which does not join the home domain tries to use content which is allowed to devices which do not join the home domain, but the content having an access authority limitation which is allowed to only devices which join the home domain. That is, although access authority of content is not limited to only devices in a home domain, when the content key for using the content is encrypted with a domain key in order to share the content only in the home domain, an authorized user that does not join the home domain will have difficulty in using the content. In this case, by providing a method for allowing an authorized user that does not join the home domain to use desired content without joining the home domain, it is possible to widen a shared range of content.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of transmitting content from a first device which joins a domain to a second device which does not join the domain, the method comprising:
determining at the first device whether adjacency exists between the first device and the second device;
encrypting a content key corresponding to the content to be transmitted to the second device using a key of the second device, according to a result of the determining whether adjacency exists between the first device and the second device; and
transmitting the encrypted content key and the content from the first device to the second device.

2. The method of claim 1, wherein the determining whether adjacency exists between the first device and the second device comprises:
transmitting an adjacency checking message from the first device to the second device;
receiving at the first device a response message from the second device;
determining a round trip time (RTT) value based on a measured adjacency checking message transmission time and a measured response message receiving time;
comparing the RTT value with an adjacency threshold value; and
determining that the first device is adjacent to the second device based on a result of the comparing.

3. The method of claim 1, further comprising receiving at the first device a message requesting transmission of the content, from the second device.

4. The method of claim 1, further comprising checking at the first device an access authority limitation of the content to determine whether only a device which joins the domain is authorized to use the content,
wherein, in the transmitting the encrypted content key and the content to the second device, if it is determined that the content has the access authority limitation, and the content is not authorized to be used by a device which does not join the domain, the encrypted content key and the content are not transmitted to the second device.

5. The method of claim 1, wherein the key of the second device is a public key.

6. The method of claim 1, further comprising receiving at the first device a secret key of the second device through a secure path, from the second device,
wherein the key of the second device is the secret key of the second device.

7. The method of claim 1, wherein the domain comprises a home network.

8. The method of claim 1, further comprising decrypting the content key using a domain key of the domain before the encrypting of the content key using the key of the second device.

9. A computer-readable recording medium storing a computer program for executing a method of transmitting content from a first device which joins a domain to a second device which does not join the domain, the method comprising:
determining at the first device whether adjacency exists between the first device and the second device;
encrypting a content key corresponding to the content to be transmitted to the second device using a key of the second device, according to a result of the determining whether adjacency exists between the first device and the second device; and
transmitting the encrypted content key and the content from the first device to the second device.

10. The computer-readable recording medium of claim 9, wherein the determining whether adjacency exists between the first device and the second device comprises:
transmitting an adjacency checking message from the first device to the second device;
receiving at the first device a response message from the second device;
determining a round trip time (RTT) value based on a measured adjacency checking message transmission time and a measured response message receiving time;
comparing the RTT value with an adjacency threshold value; and
determining that the first device is adjacent to the second device based on a result of the comparing.

11. The computer-readable recording medium of claim 9, further comprising receiving at the first device a message requesting transmission of the content, from the second device.

12. The computer-readable recording medium of claim 9, further comprising checking at the first device an access authority limitation of the content to determine whether only a device which joins the domain is authorized to use the content,
wherein, in the transmitting the encrypted content key and the content to the second device, if it is determined that the content has the access authority limitation, and the content is not authorized to be used by a device which does not join the domain, the encrypted content key and the content are not transmitted to the second device.

13. The computer-readable recording medium of claim 9, wherein the key of the second device is a public key.

14. The computer-readable recording medium of claim 9, further comprising receiving at the first device a secret key of the second device through a secure path, from the second device,
wherein the key of the second device is the secret key of the second device.

15. A method of allowing a second device which does not join a domain to receive content from a first device which joins the domain, the method comprising:
determining whether adjacency exists between the first device and the second device; and
receiving the content and a content key corresponding to the content encrypted using a key of the second device, from the first device, according to a result of the determining whether adjacency exists between the first device and the second device.

16. The method of claim 15, wherein the determining whether adjacency exists between the first device and the second device comprises:
receiving an adjacency checking message from the first device;
transmitting a response message to the first device;
determining a round trip time (RTT) value based on a measured adjacency checking message receiving time and a measured response message transmission time;
comparing the RTT value with an adjacency threshold value; and
determining that the first device is adjacent to the second device based on a result of the comparing.

17. The method of claim 15, further comprising transmitting a message requesting transmission of the content, to the first device.

18. The method of claim 15, further comprising:
decrypting the received content key using the key of the second device; and
decrypting the received content using the decrypted content key.

19. The method of claim 15, further comprising, if the content key is encrypted using a public key, decrypting the received content key using a private key of the second device, and decrypting the received content using the decrypted content key.

20. The method of claim 15, further comprising:
transmitting a secret key of the second device through a secure path from the second device to the first device; and
if the content key is encrypted with the secret key, decrypting the received content key with the secret key, and decrypting the received content with the decrypted content key.

21. The method of claim 15, wherein the domain comprises a home network.

22. A computer-readable recording medium storing a computer program for executing a method of allowing a second device which does not join a domain to receive content from a first device which joins the domain, the method comprising:
determining at the second device whether adjacency exists between the first device and the second device; and
receiving the content and a content key corresponding to the content encrypted using a key of the second device, from the first device, according to a result of the determining whether adjacency exists between the first device and the second device.

23. The computer-readable recording medium of claim 22, wherein the determining whether adjacency exists between the first device and the second device comprises:
receiving an adjacency checking message from the first device;
transmitting a response message to the first device;
determining a round trip time (RTT) value based on a measured adjacency checking message receiving time and a measured response message transmission time;
comparing the RTT value with an adjacency threshold value; and
determining that the first device is adjacent to the second device based on a result of the comparing.

24. The computer-readable recording medium of claim 22, further comprising transmitting a message requesting transmission of the content, to the first device.

25. The computer-readable recording medium of claim 22, further comprising:
decrypting the received content key using the key of the second device; and
decrypting the received content using the decrypted content key.

26. The computer-readable recording medium of claim 22, further comprising, if the content key is encrypted using a public key, decrypting the received content key using a private key of the second device, and decrypting the received content using the decrypted content key.

27. The computer-readable recording medium of claim 22, further comprising:
transmitting a secret key of the second device through a secure path from the second device to the first device; and
if the content key is encrypted with the secret key, decrypting the received content key with the secret key, and decrypting the received content with the decrypted content key.

28. An apparatus for transmitting content to a device which does not join a domain, the apparatus comprising:
an adjacency checking unit which determines adjacency to the device;
an encryption unit which encrypts a content key corresponding to the content to be transmitted to the device, using a key of the device, according to an adjacency determination result of the adjacent checking unit; and
a transmitting unit which transmits the content key encrypted by the encryption unit and the content corresponding to the content key to the device.

29. The apparatus of claim 28, wherein the adjacency checking unit is configured to:
transmit an adjacency checking message to the device;
receive a response message from the device;
determine a round trip time (RTT) value based on a measured adjacency checking message transmission time and a measured response message receiving time;
compare the RTT value with an adjacency threshold value; and
determine that the apparatus is adjacent to the device based on a result of the comparing.

30. The apparatus of claim 28, further comprising a receiver which receives a message requesting transmission of the content from the device.

31. The apparatus of claim 28, further comprising a determination unit which determines whether the content has an access authority limitation, and the content is used by only a device which joins the domain,
wherein, if the determination unit determines that the content is content having the access authority limitation, and the content is not used by a device that does not join the domain, the transmitting unit does not transmits the content key encrypted by the encryption unit and the content corresponding to the content key to the device.

32. The apparatus of claim 28, wherein the domain comprises a home network.

33. An apparatus for receiving content from a device which joins a domain, the apparatus comprising:
an adjacency checking unit which determines adjacency to the device; and
a receiver which receives a content key encrypted using a key of the apparatus and the content corresponding to the content key, according to an adjacency determination result of the adjacency checking unit.

34. The apparatus of claim 33, wherein the adjacency checking unit is configured to:
receive an adjacency checking message from the device; and
transmit a response message to the device,
wherein the device determines a round trip time (RTT) value based on a measured adjacency checking message receiving time and a measured response message transmission time, compare the RTT value with an adjacency threshold value, and determine that the device is adjacent to the apparatus based on a result of the comparing.

35. The apparatus of claim 33, further comprising a requesting unit which transmits a message requesting transmission of the content to the device.

36. The apparatus of claim 33, further comprising:
a first decryption unit which decrypts the encrypted content key received from the receiver using the key of the apparatus; and
a second decryption unit which decrypts the content key received from the receiver using the content key decrypted by the first decryption unit.

37. The apparatus of claim 33, wherein the domain comprises a home network.

38. A method of transmitting content from a first device to a second device, the method comprising:
receiving a content request from the second device;
determining whether the second device does not join a domain of the first device;
determining whether transmittance of the content is allowed on the basis of a license of the content if the second device does not join the domain of the first device;
measuring a physical distance from the first device to the second device; and
transmitting the content to the second device according to a result of the measuring of the physical distance.

39. The method of claim 38, wherein the license includes information for an available range of the content.

40. The method of claim 38, wherein a content key for encrypting the content is encrypted by a domain key of the domain.
